(19) United States
(12) Patent Application Publication
(10) Pub. No.: US 2007/0242324 A1
(43) Pub. Date: Oct. 18, 2007

(54) Method for producing an active, real and three-dimensional image

(76) Inventor: Li-Hung Chen, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/709,087

(22) Filed: Feb. 22, 2007

(30) Foreign Application Priority Data
Apr. 18, 2006 (TW) 095113720

(51) Int. Cl. G03H 1/08

(52) U.S. Cl. 359/9

(57) ABSTRACT

A method for producing an active, real and three-dimensional image includes a three-dimensional region evenly spread with fluorescent agents, and a plurality of invisible lasers projecting in the three-dimensional region from different directions. The fluorescent agents positioned at a location focused by all of the invisible lasers are excited to generate fluorescence of visible wavelength. And, via rapidly scanning the invisible lasers in the three-dimensional region back and forth to cross at different locations, an active, real and three-dimensional image can be seen due to afterimage of eyes.

### BACKGROUND OF THE INVENTION

1. Field of the Invention

This invention relates to a method for producing an active, real and three-dimensional image.

2. Description of the Prior Art

Nowadays, there are many kinds of drawings, images, animations or the like used in advertisements, promotions or for building an atmosphere or being as a decoration in some activities.

The drawings, images, animations or the like are generally projected on a plane or high in the air, or displayed on a screen. Although they can reach the expected efficacy, they are often becoming devoid of changes and dull in this era which is changed incessantly. Besides, they can only be shown on a plane or a screen without three-dimensional performance, revealing that a great number of improvements remain to be done.

### SUMMARY OF THE INVENTION

The present invention relates to offer a method for producing an active, real and three-dimensional image.

The main characteristics of the invention include a three-dimensional region evenly spread with fluorescent agents, and plural invisible-light lasers projecting in the three-dimensional region from different directions. The fluorescent agents positioned at a location focused by all of the invisible lasers are to be excited to generate fluorescence of visible wavelength. Based on the invisible lasers rapidly scanning in the three-dimensional region back and forth to cross at different locations, an active, real and three-dimensional image can be seen due to afterimage of eyes.

### BRIEF DESCRIPTION OF DRAWINGS

This invention is better understood by referring to the accompanying drawings, wherein:

FIG. 1 is a block chart of a preferred embodiment of a method for producing an active, real and three-dimensional image in the present invention, illustrating relationship between its components;

FIG. 2 is a partial block chart of the preferred embodiment of a method for producing an active, real and three-dimensional image in the present invention, illustrating how it functions partially; and

FIG. 3 is a block chart of the preferred embodiment of a method for producing an active, real and three-dimensional image in the present invention, showing it being operated.

### DETAILED DESCRIPTION OF THE PREFERRED EMBODIMENT

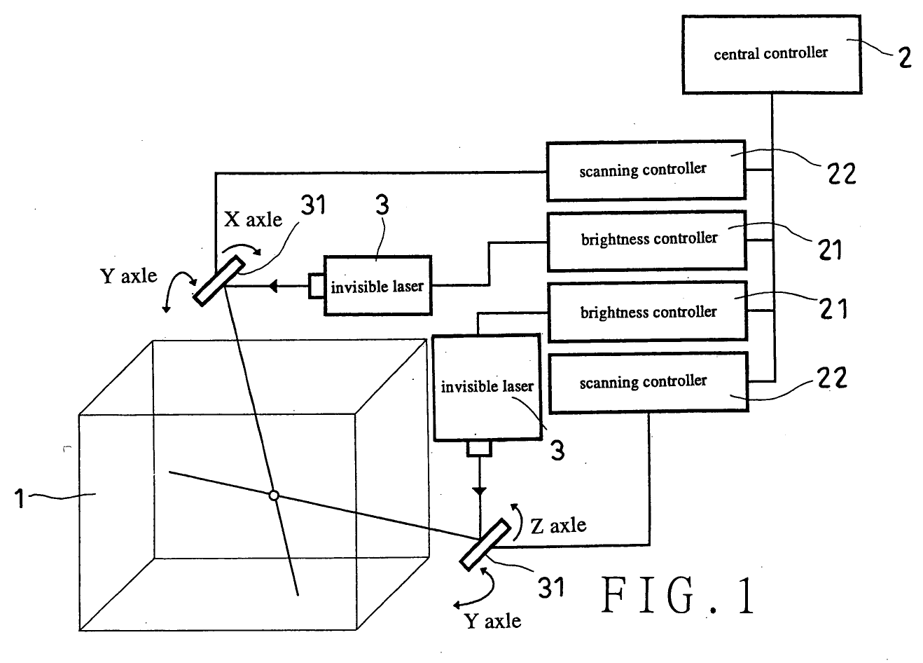

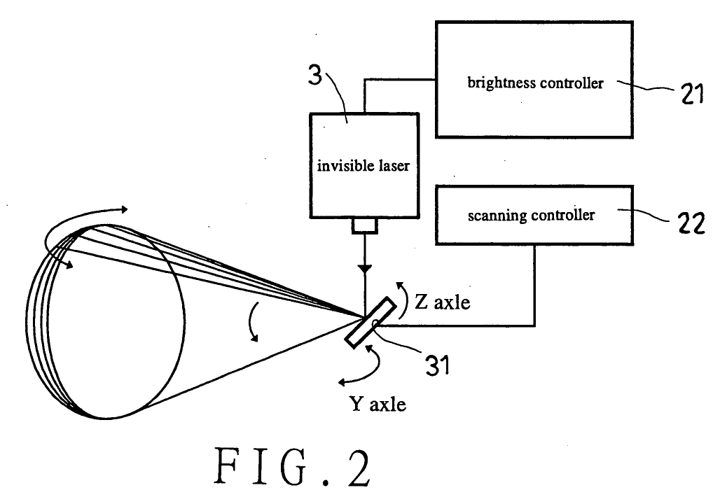

As shown in FIGS. 1 and 2, a preferred embodiment of a method for producing an active, real and three-dimensional image in the present invention is provided with a three-dimensional region 1 evenly spread with fluorescent agents [DAPI (4′,6-diamidino-2-phenylindole)], a central controller 2 and a plurality of invisible lasers 3 [two-photon laser (Ti-Sapphire), wavelength: 702 nm] aimed at the three-dimensional region 1 from diverse directions. The central controller 2 is linked respectively with a plurality of brightness controllers 21 and a scanning controller 22. Each of the invisible lasers 3 is installed with a corresponding reflection device 31 and the invisible lasers 3 connects with the scanning controller 22 of the central controller 2; besides, the reflecting device 31 is connected with the scanning controller 22 of the central controller 2. The central controller 2 can control the power output of the invisible lasers 3 by means of the brightness controller 21, and the reflection device 31 can be adjusted to move at different directions and different angles by means of the scanning controller 22.

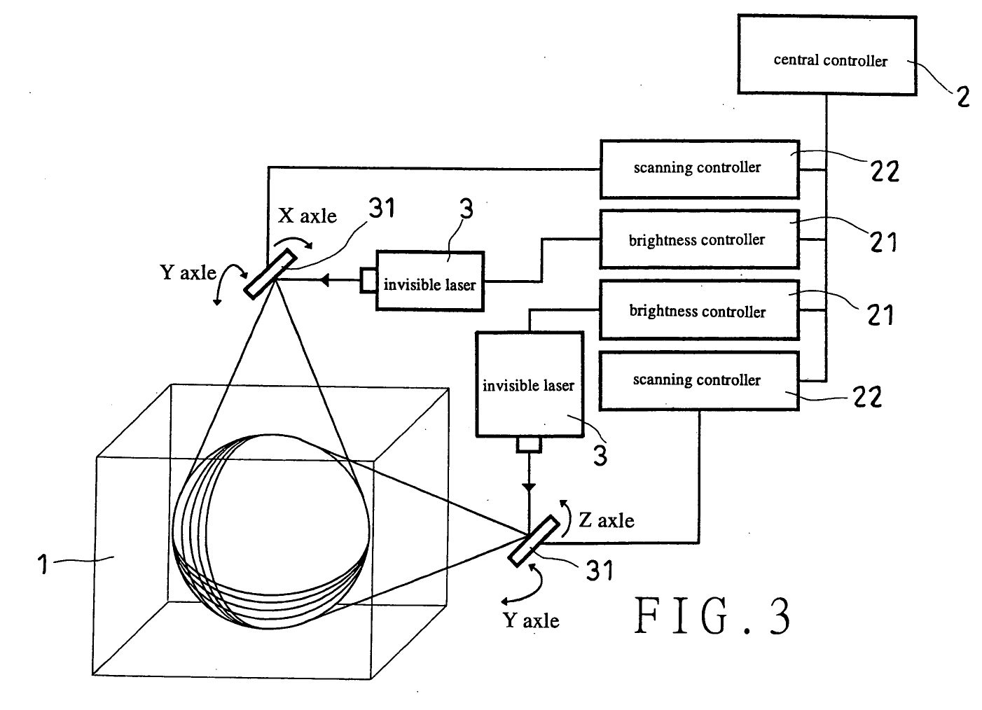

Accordingly, as shown in FIG. 3, different independent laser lights are respectively emitted to the reflection device 31 from the invisible lasers 3 controlled by the brightness controller 21 of the central controller 2; then, the scanning controller 22 is used to suitably shift the direction and the angle of the reflection device 31 for allowing each of the invisible lasers 3 to be crossed on the fluorescent agents positioned on the same location in the three-dimensional region 1. By adding energy [Excitation wavelength (EX): 375±20 nm] to excite the fluorescent agents for shifting the energy level of the fluorescent agents, the fluorescent agents are excited to generate fluorescence of visible wavelength [Emission wavelength (EM): 452 nm]. Besides, the power of the invisible lasers 3 can be altered by the brightness controller 21 to change the brightness of fluorescence. By the time, the fluorescent agents spread among other locations can not become visible as they are not excited by the invisible lasers 3 or are excited only by a single invisible laser 3 without sufficient excitation. Then, the reflection device 31 is controlled by the scanning controller 22 to continuously change the direction and the angle of the reflection device 31 quickly so as to keep the invisible laser 3 being swept to project in the three-dimensional region 1 for generating an active, real and three-dimensional image owing to visual afterimage. In addition, different kinds of the fluorescent agents and the invisible lasers with diverse wavelengths can be simultaneously applied to form different colors of point lights for forming a colorful vivid dynamic image. Further speaking, different kinds of fluorescent agents and invisible lasers with diverse wavelengths can be appropriately applied in the present invention.

The invisible lasers 3 are projected into the three-dimensional region 1 to focus on one specific location, whose fluorescent agents are excited to generate fluorescent light spots. Then, via rapidly scanning the invisible lasers 3 in the three-dimensional region 1, an active, real and three-dimensional image can be seen due to afterimage of eyes. And, because the invisible laser is an invisible light, the projecting pace of the invisible laser is invisible, too.

While the preferred embodiment of the invention has been described above, it will be recognized and understood that various modifications may be made therein and the appended claims are intended to cover all such modifications that may fall within the spirit and scope of the invention.

What is claimed is:

1. A method for producing an active, real and three-dimensional image comprising:
a three-dimensional region evenly spread with fluorescent agents;
a central controller;
a plurality of invisible lasers aimed at said three-dimensional region from diverse directions and controlled by said central controller; and
manipulating said central controller to keep all said invisible lasers emitting laser lights to focus on said fluorescent agents positioned at the same location in said three-dimensional region, said fluorescent agents to be excited to generate fluorescence of visible wavelength by adding energy to excite said fluorescent agents for shifting the energy level of said fluorescent agents, said invisible lasers swept quickly to continue projecting in said three-dimensional region to form an active, real and three-dimensional image due to afterimage of eyes.

2. A method for producing an active, real and three-dimensional image as claimed in claim 1, wherein said central controller is linked respectively with a plurality of brightness controllers and a scanning controller; besides, a reflection device is provided to correspond to each of said invisible lasers, said invisible lasers connected with said brightness controller for controlling the power output of said invisible lasers, said reflection device connected with said scanning controller for shifting the direction and angle of said reflection device.

3. A method for producing an active, real and three-dimensional image as claimed in claim 1, wherein said three-dimensional region is applied with different kinds of fluorescent agents and said invisible lasers of diverse wavelengths, so as to form spot lights of different colors for producing a colorful active, real and three-dimensional image.
